(19) United States
(12) Patent Application Publication
(10) Pub. No.: US 2007/0139576 A1
(43) Pub. Date: Jun. 21, 2007

(54) Display module for an electronic device

(76) Inventors: Alexander Hunt, Malmo (SE); Martin Grip, Malmo (SE)

Correspondence Address: MYERS BIGEL SIBLEY & SAJOVEC, PO BOX 37428, RALEIGH, NC, 27627, US

(21) Appl. No.: 11/314,800

(22) Filed: Dec. 21, 2005

(51) Int. Cl. G02F 1/1333

(52) U.S. Cl. 349/58

(57) ABSTRACT

A display module which is to be mounted on a printed circuit board of an electronic device includes a display element. The display module further includes at least two thin layers of a transparent material, such as glass or other similar material. The display element and the at least two thin layers of rigid transparent material are part of a laminated structure where the different layers of the laminated structure are attached together with an adhesive. In this way a stronger and more robust display module is provided. This allows the thickness of the housing of the electronic device to be reduced since there is no need for a protective glass plate and an air gap in front of the display module.

### REFERENCE TO RELATED APPLICATION

This application claims the benefit of, and priority to, provisional Application No. ______, filed Dec. 20, 2005, entitled “Display Module Which Is To Be Mounted On A PCB,” Attorney Docket 9561-5PR, the disclosure of which is hereby incorporated by reference herein as if set forth in its entirety.

### FIELD OF THE INVENTION

The current invention relates to display modules. In particular, the present invention relates to display modules that are configured to be mounted on a printed circuit board of an electronic device.

### BACKGROUND

Display modules, which include display elements, are typically used in mobile electronic devices, such as mobile telephones, PDAs, personal music devices and so on. It should be mentioned that the term “display element” may include any type of element which acts as a display. A typical example is a Liquid Crystal Display (LCD). An LCD includes a transparent electrode plate arranged on each side of a liquid crystal. There are however, many other forms of displays, for example OLED displays and Bi-stable displays. New display technologies are also being developed constantly. Therefore, the term display element should be interpreted widely and should not be associated with a single display technology.

A display module may be mounted on a printed circuit board (PCB) of an electronic device. The printed circuit board of electronic devices is typically arranged within a protective housing and the display module is protected from damage by a glass or plastic plate arranged over the display element and attached to the housing. The glass or plastic plate is separated from the display element by an air gap. The air gap serves to protect the display element from damage since shocks applied to the protective glass or plastic plate may not be transmitted to the display element. This type of prior art assembly is shown in FIG. 1.

However, this type of prior art assembly may suffer from the disadvantage that due to the air gap and the thick protective plate, the distance between the PCB and the outer surface of the protective plate may be quite large. This means that the electronic device may become rather thick.

In other types of displays, in order to increase the strength of the display, the PCB and the display module may be separated. In these types of devices, the display module may be directly fastened to the protective plate which is attached to the housing of the device. The display module is then connected to the PCB of the electronic device via a cable. However, this setup is also typically rather thick since there may be an air gap between the rear of the display module and the PCB. This arrangement is therefore typically used in larger electronic devices where there is more room. It would however, not be suitable for use in typical mobile devices, such as mobile phones, due to the limited space available in mobile devices. For two examples of this type of arrangement please refer to U.S. Pat. No. 6,252,639 B1 and U.S. Pat. No. 5,606,438.

### SUMMARY OF THE INVENTION

It is therefore one aspect of the current invention to provide a display module as mentioned in the opening paragraph which is stronger and more robust than the display modules known from the prior art.

A second aspect of the current invention is to provide a display module which allows the mechanical construction of the electronic device to be slimmer.

One or more of the above mentioned aspects may be addressed in part by a display module including at least two thin layers of rigid transparent material, such as glass or another similar material, with the display element and the at least two thin layers of rigid transparent material being part of a laminated structure where the different layers are attached together, for example with an adhesive. Since the display element is part of a laminated structure, the display module may become much stronger than known in the prior art. Since the display module is stronger, the protective glass and the air gap are may not be necessary. This means that the thickness of the electronic device in which the display is used can be significantly reduced when compared to the prior art solutions. The robustness of the display module may also be increased, since shock loads may be absorbed more effectively by a laminated structure than by a single glass or plastic plate. This may result in fewer broken displays.

For the sake of this specification, a laminated structure should be understood as a structure including different layers of material attached together, for example by adhesives. Furthermore, it should be noted that the at least two thin layers of rigid transparent material could be at least two different types of material. In other words the laminated structure could include layers of many different materials.

In some embodiments of the current invention, at least two thin layers of rigid transparent material separated by an adhesive are arranged at the front of the display element. It should be noted, for the sake of this specification, that the terms “front” and “rear”, when used with respect to the display element, should be interpreted as referring respectively to the side of the display element which will be viewed by the user and the side of the display element which faces away from the user.

In some embodiments, at least one thin layer of rigid transparent material is arranged at the rear of the display element. This may further increase the strength of the display module.

In a preferred embodiment, the display module could include at least one polarizer. The polarizer could, in some embodiments, be arranged as the outermost layer of the display module. The display module could also include a polarizer arranged at the rear of the display element.

Furthermore, in order to increase the lifetime of the display module, the outermost layer of the laminated structure could be a scratch resistant layer. In some embodiments, the scratch resistant layer could be a thick polarizer.

In some embodiments, the display module could further include a light providing element, such as a backlight or a light guide, arranged at the rear of the display element.

The display module may be used together with a mobile electronic device. One example of a mobile electronic device is a mobile telephone.

### BRIEF DESCRIPTION OF THE DRAWINGS

The present invention will now be described more fully with reference to the accompanying drawings in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. The thickness of various layers may be exaggerated for clarity.

FIG. 1 shows a cross-sectional view of a prior art display module;

FIG. 2 shows a cross-sectional view of a display module according to some embodiments of the current invention; and

FIG. 3 shows a cross-sectional view of a display module according to further embodiments of the current invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As described above, a display module may be mounted on a printed circuit board (PCB) of an electronic device. By “mounted on a PCB”, it is meant that the display module may be fastened onto the PCB, either directly or indirectly. This could for example be the case when the display module is itself mounted on the PCB, or it could be the case when the display module is mounted in a support frame which is mounted on the PCB. In many cases, the display is arranged inside a support frame which stiffens the housing of the electronic device. However, both the indirect mounting and the direct mounting cases should be covered within the scope of the current invention.

Please note that the examples shown below all relate to the display of a mobile telephone. However, as has been mentioned previously, the display according to the current invention can be used in many different applications and is not limited to mobile telephones.

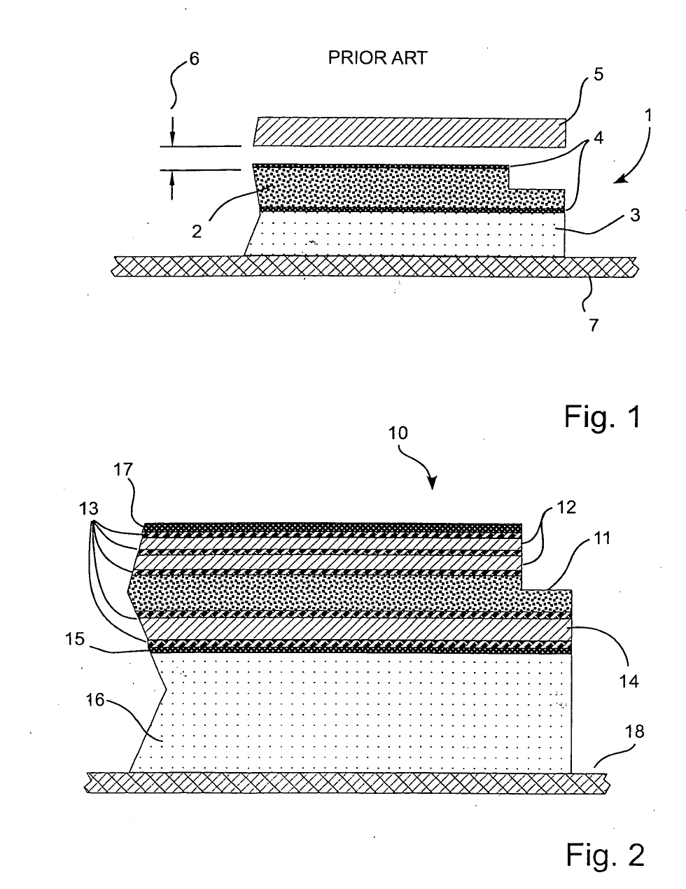

FIG. 1 shows the prior art method of protecting a display module 1 from damage. The display module 1 includes the display element 2, a backlight 3 and one polarizer 4 arranged on either side of the display element 2. The display element 2 is of the liquid crystal type and is formed as should be known to the person skilled in the art. A protective glass plate 5 is arranged over the display module 1 and an air gap 6 is provided between the protective glass plate 5 and the top surface of the display element 2. In order to provide proper protection, the air gap 6 may be at least a certain size. The display module 1 is mounted on a printed circuit board (PCB) 7.

The distance from the outermost surface of the protective glass plate to the PCB of a typical prior art display arrangement can be calculated as follows. A typical display element 2 includes a transparent electrode plate with a thickness of about 0.5 mm arranged on either side of a liquid crystal. Additional films with a total thickness of about 0.3 mm are also present in most displays. These films serve different purposes depending on the application of the display module. One example of a typical additional film is a film for increasing the brightness of the display by aligning the light from the backlight 3 with the rear polarizer 4. The polarizers 4 have a typical thickness of about 0.15 mm and the backlight 3 has a thickness of about 1 mm. The total thickness of the display module is therefore around 2.6 mm. The air gap 6 has a thickness of about 0.5-1 mm and the protective glass plate 5 has a thickness of about 1.5 mm. The distance from the PCB board to the outside of the protective glass plate 5 is therefore typically between 4.6 and 5.1 mm. This distance is usually the highest point on the topside of the PCB 7, and it may thereby directly affect the thickness of the device in which the display 1 is used.

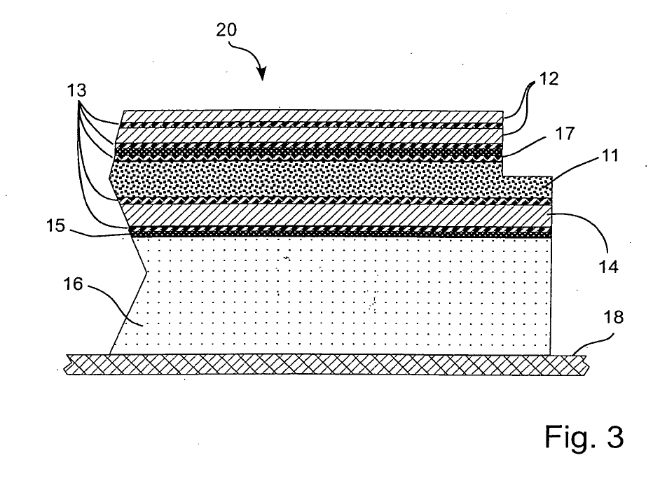

In contrast to the prior art solution shown in FIG. 1, the display modules 10,20 shown in FIGS. 2 and 3 may have increased strength and/or robustness. They therefore may not need a protective glass plate and/or an air gap. In this way, the thickness of the actual display module may be increased, but the overall distance between the exposed surface above the display element and the surface of the PCB may be reduced. This may decrease the overall thickness of the handset and/or improve the general appearance of the device.

The display module 10 includes a display element 11 of the liquid crystal type. As discussed previously, the display element 11 includes two transparent electrode plates (not shown) and a liquid crystal arranged between the two plates. On the outer surface of the display element 11, a laminated structure is arranged which includes two thin sheets of a rigid transparent material 12, such as glass or another similar material, separated by an adhesive 13. A further thin sheet of rigid transparent material 14 may be arranged on the rear side of the display element 11. A thin polarizer 15 is arranged between the display element 11 and the backlight 16. A thick polarizer 17 is arranged on the outermost surface of the display module 10. This thicker polarizer 17 may act as a scratch resistant layer. The display module 10 is mounted on a PCB 18.

The laminated structure of the rigid transparent layers 12 may act in a similar manner as armored glass. By laminating thin layers of rigid transparent material 12 such as glass together with the display element 11, the complete display module 10 may become more resistant to dropping and/or pressure. This is because the adhesive 13 may allow the thin layers of the display module to displace slightly with respect to each other when pressure and/or shock is applied to the display module 10. In this way, the display module may become less fragile and the risk of shattering a display during, for example a drop test, an impact test, a pressure test, etc. may be reduced.

The thickness of an example display module according to some embodiments of the current invention can be calculated as follows. Since the display module according to some embodiments of the current invention includes additional rigid transparent layers, the transparent electrode plates can be made thinner than in the prior art case. In the current example, the transparent electrode plates may be about 0.4 mm. As with the previous example, additional films with a thickness of about 0.3 mm are also present. This results in a display element with a total thickness of about 1.1 mm. The three sheets of transparent material 12,14 are each about 0.3 mm thick. The adhesive layers 13 are each about 0.05 mm thick. The light guide thickness 16 is about 1 mm and the polarizers 15,17 are about 0.10 mm and 0.20 mm thick respectively. This results in a total thickness of about 3.55 mm. This is significantly lower than the thickness of 4.6-5.1 mm of the prior art case.

The order of the different layers can be modified. For example the order of the layers of the display module 20 shown in FIG. 3 is slightly different than the order of the layers of the display module 10 shown in FIG. 2. In the display module 20, the polarizer 17 arranged at the front of the display element has been placed adjacent the display element 11, instead of outermost as was the case with the display module 10 shown in FIG. 2. In this way, the rigid transparent layers 12 are now the outermost layers. In this case, the outermost rigid transparent layer 12 could be made from a more scratch resistant material.

It should also be noted that the choice of materials, components, and adhesives will depend on the particular case. The person skilled in the art should be familiar with the properties of different suitable materials and should be able to easily choose appropriate materials, components and adhesives.

Furthermore, as should be known to the person skilled in the art, displays of differing display technologies have different thicknesses due to their construction. For example an OLED type display will be thinner than a Liquid Crystal type display. Therefore, the effects of the current invention are especially applicable when used together with a display technology which has a slim design.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A display module for an electronic device, the display module comprising:
a display element, and
at least two thin layers of rigid transparent material;
wherein the display element and the at least two thin layers of rigid transparent material are part of a laminated structure in which different layers of the laminated structure are attached together with an adhesive.

2. A display module according to claim 1, wherein the at least two thin layers of rigid transparent material are separated by an adhesive and are arranged at a front of the display element.

3. A display module according to claim 1, wherein the at least one thin layer of rigid transparent material is arranged at a rear of the display element.

4. A display module according to claim 1, wherein the display module further comprises at least one polarizer arranged at a front of the display element and at least one polarizer arranged at a rear of the display element.

5. A display module according to claim 4, wherein the polarizer arranged at the front of the display element comprises an outermost layer of the display module.

6. A display module according to claim 1, wherein an outermost layer of the display module comprises a scratch resistant layer.

7. A display module according to claim 1, wherein the display module further comprises a lighting element arranged at a rear of the display element.

8. A mobile electronic device comprising a display module according to claim 1.

9. A mobile electronic device according to claim 8 wherein the mobile electronic device comprises a mobile telephone.

10. A printed circuit board on which is mounted a display module according to claim 1.

11. A display module according to claim 1, wherein the at least two layers of rigid transparent material comprise a first layer of a first rigid transparent material and a second layer of a second rigid transparent material, wherein the second rigid transparent material is different from the first rigid transparent material.

12. A display module according to claim 1, wherein the rigid transparent material comprises glass.
